(19) United States
(12) Patent Application Publication
(10) Pub. No.: US 2022/0397282 A1
(43) Pub. Date: Dec. 15, 2022

(54) SUPPORTING UNIT FOR A BARBECUE GRILL

(71) Applicant: INDUSTRO INTERNATIONAL CO., LTD., Taichung City (TW)

(72) Inventor: KUO-CHAN HUANG, Taichung (TW)

(21) Appl. No.: 17/347,610

(22) Filed: Jun. 15, 2021

(51) Int. Cl. F24C 15/10; F24C 1/16; A47J 37/07

(52) U.S. Cl. CPC F24C 15/107; F24C 1/16; A47J 37/0763; A47J 2037/0777

(57) ABSTRACT

A barbecue grill includes a barrel and a supporting unit. The barrel includes multiple panels and two lugs. The panels are pivotally connected to one another so that the barrel is switchable between an extended position and a collapsed position. The lugs are formed on one of the panels. The supporting unit includes a frame and multiple loops. The frame includes two lateral sections and two pivots. The lateral sections extend parallel to each other. The pivots extend from the lateral sections, respectively. The pivots are inserted in the lugs when the lateral sections are released. The pivots are disengaged from the lugs when the lateral sections are moved relative to each other. The loops are located on and connected to the lateral sections.

### BACKGROUND OF INVENTION

### 1. Field of Invention

The present invention relates to a barbecue grill and, more particularly, to a supporting unit for a barbecue grill.

### 2. Related Prior Art

To start a fire, a torch is often used to ignite tinder before the burning tinder is used to ignite charcoal. A fan is often used to facilitate the ignition of the charcoal because it is difficult to ignite the charcoal. The use of the fan is exhausting.

To solve the foregoing problem, U.S. Pat. No. 5,682,872, FIGS. 4a and 4b, has disclosed a collapsible barrel to facilitate the ignition of charcoal. This collapsible barrel includes multiple sections 24 pivotally connected to one another by hinge pins 19. The sections 24 are separated from one another when the hinge pins 19 are removed. It is however troublesome to store the sections 24 and the hinge pins 19 since they are separated from one another.

U.S. Pat. No. 8,028,689 has disclosed a collapsible fire starter for facilitating ignition of charcoal. The fire starter is located in a collapsed position when it is not in use. In use, the fire starter is located in an extended position. However, the fire starter cannot be used as a stove or a barbecue grill for it is not suitable for supporting a cooking utensil such as pan, a pot and a grid. Therefore, to cook, a barbecue grill or a stove has to be used in addition to the fire starter, and this is troublesome.

The present invention is therefore intended to obviate or at least alleviate the problems encountered in the prior art.

### SUMMARY OF INVENTION

It is the primary objective of the present invention to provide a collapsible barbecue grill.

To achieve the foregoing objective, the barbecue grill includes a barrel and a supporting unit. The barrel includes multiple panels and two lugs. The panels are pivotally connected to one another so that the barrel is switchable between an extended position and a collapsed position. The lugs are formed on one of the panels. The supporting unit includes a frame and multiple loops. The frame includes two lateral sections and two pivots. The lateral sections extend parallel to each other. The pivots extend from the lateral sections, respectively. The pivots are inserted in the lugs when the lateral sections are released. The pivots are disengaged from the lugs when the lateral sections are moved relative to each other. The loops are located on and connected to the lateral sections.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a supporting unit for a barbecue grill according to the preferred embodiment of the present invention;

FIG. 2 is a side view of the supporting unit shown in FIG. 1;

FIG. 3 is a top view of the supporting unit shown in FIG. 1;

FIG. 4 is a perspective view of a barbecue grill including a collapsible barrel and the supporting unit shown in FIG. 1;

FIG. 5 is a top view of the barbecue grill in a collapsed position other than shown in FIG. 4; and

FIG. 6 is a perspective view of the barbecue grill shown in FIG. 5.

### DETAILED DESCRIPTION OF PREFERRED EMBODIMENT

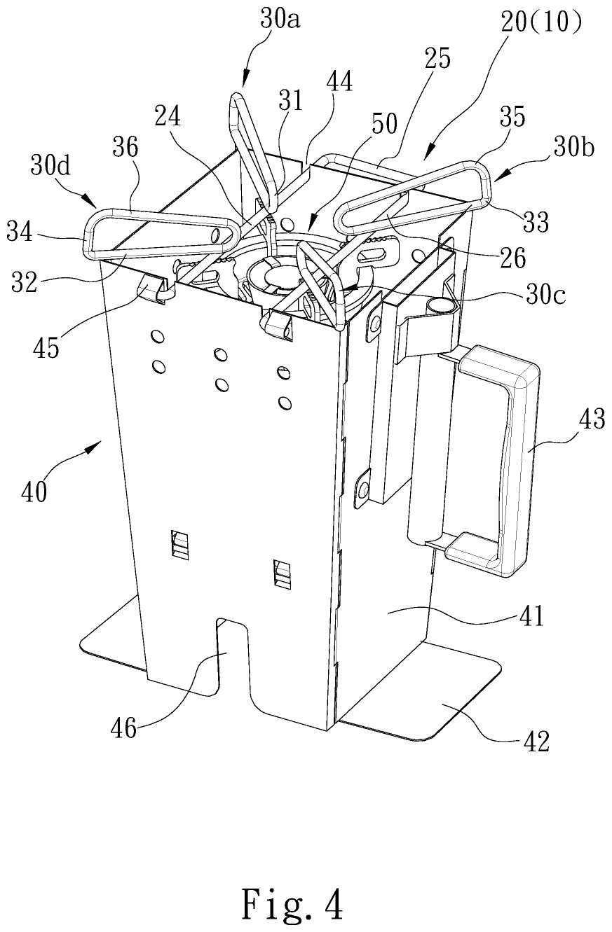

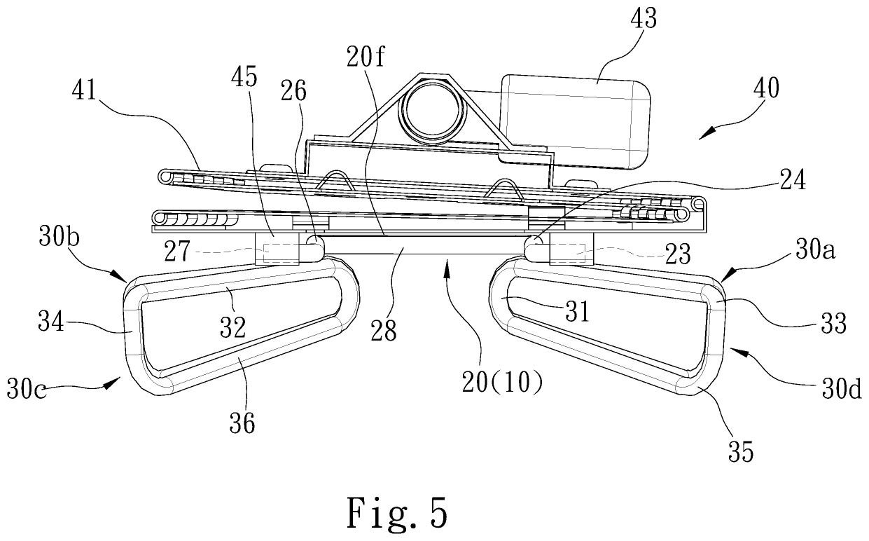

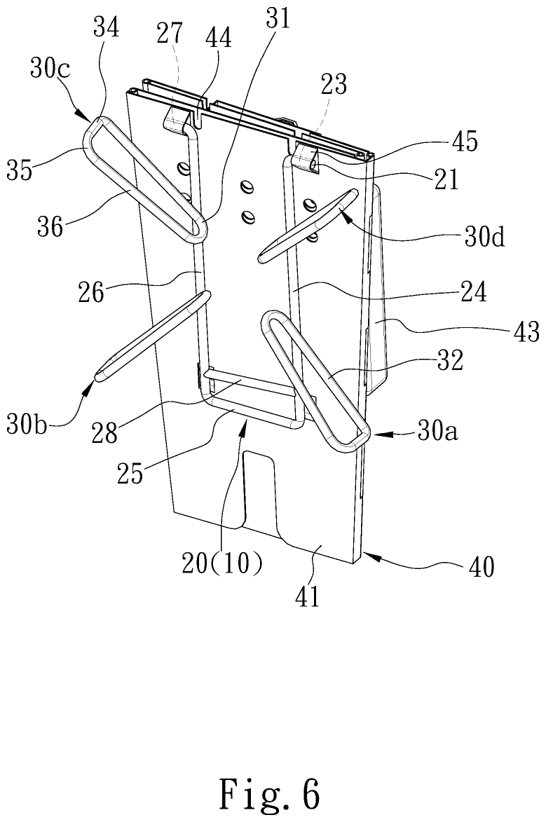

Referring to FIG. 4, a barbecue grill includes a barrel 40 for supporting a supporting unit 10 according to the preferred embodiment of the present invention. The barrel 40 is collapsible (FIGS. 5 and 6).

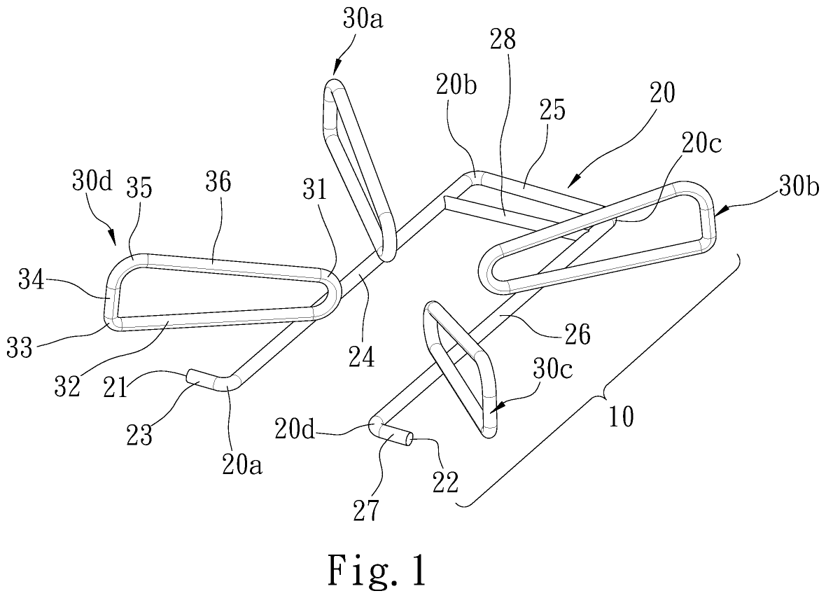

Referring to FIG. 1, the supporting unit 10 includes a frame 20 connected to four loops 30a, 30b, 30c and 30d. The loops 30a, 30b, 30c and 30d are evenly located on the frame 20. The frame 20 is made of a short metal bar 28 and a long metal bar (not numbered). The long metal bar includes two ends 21 and 22 and is bent to provide four bent sections 20a, 20b, 20c and 20d, two lateral sections 24 and 26, an intermediate section 25 and two pivots 23 and 27. The pivot 23 extends between the end 21 and the bent section 20a. The lateral section 24 extends between the bent sections 20a and 20b. The intermediate section 25 extends between the bent sections 20b and 20c. The lateral section 26 extends between the bent sections 20c and 20d. The pivot 27 extends between the bent section 20d and the end 22.

The lateral section 24 extends perpendicular to the pivot 23. The intermediate section 25 extends perpendicular to the lateral section 24. The lateral section 26 extends perpendicular to the intermediate section 25. The pivot 27 extends perpendicular to the lateral section 26. The pivots 23 and 27 extend along a common axis. The lateral sections 24 and 26 extend parallel to each other. The intermediate section 25 extends parallel to the common axis of the pivots 23 and 27.

The short bar 28 is used as a reinforcing bar. The reinforcing bar 28 includes an end connected to the lateral section 24 by welding for example and another end connected to the lateral section 26. The reinforcing bar 28 extends parallel to the intermediate section 25.

The pivots 23 and 27 are connected to the barrel 40 so that the supporting unit 10 is allowed to pivot on the barrel 40.

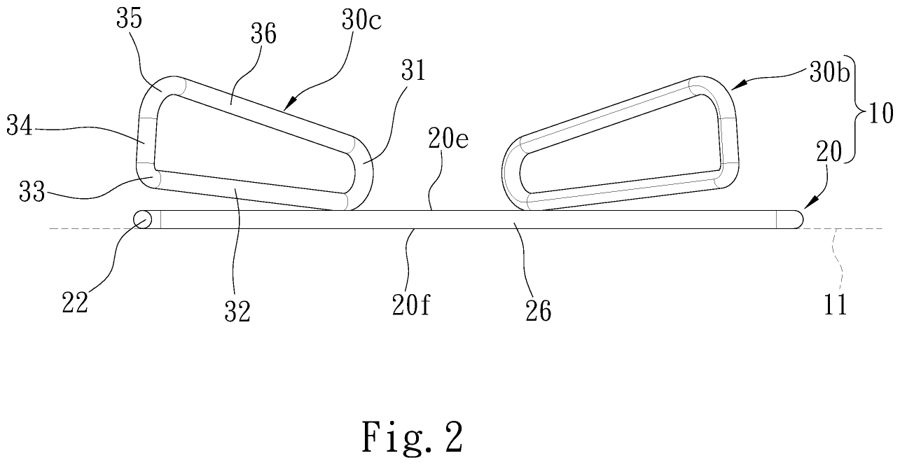

The loops 30a and 30d are connected to the lateral section 24 by welding for example. The loops 30b and 30c are connected to the lateral section 26 by welding for example. The loops 30a, 30b, 30c and 30d identical to one in shape. For example, each of the loops 30a, 30b, 30c and 30d includes an arched section 31, a horizontal section 32, a vertical section 34, an apex 35 and a slant section 36. The arched section 31 is formed between the horizontal section 32 and the slant section 36. The bent section 33 is formed between the vertical section 34 and the horizontal section 32. The apex 35 is formed between the vertical section 34 and the slant section 36. The slant section 36 extends downward to the arched section 31 from the apex 35 (FIG. 2).

The horizontal section 32 of the loop 30a or 30d is connected to the lateral section 24 by welding for example. The horizontal section 32 of the loop 30b or 30c is connected to the lateral section 26 by welding for example.

Referring to FIG. 2, a side view of the supporting unit 10, the lateral section 26 shields the lateral section 24 (not shown). The frame 20 includes a top 20e and a bottom 20f The bottom 20f extends along a horizontal phantom line 11.

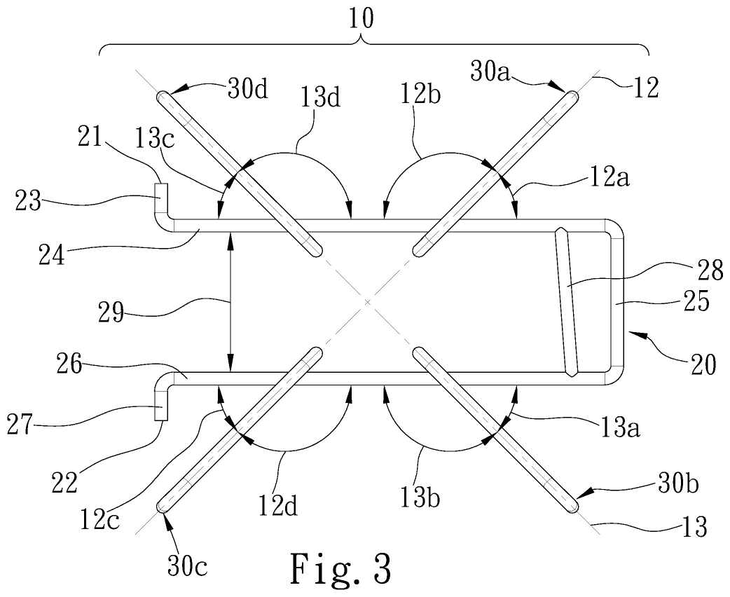

Referring to FIG. 3, a top view of the supporting unit 10, the loops 30a and 30c extend along a phantom line 12 that intersects the lateral sections 24 and 26. There is an acute angle 12a and an obtuse angle 12b between the phantom line 12 and the lateral section 24. The acute angle 12a is supplementary to the obtuse angle 12b. There is an acute angle 12c and an obtuse angle 12d between the phantom line 12 and the lateral section 26. The acute angle 12c is supplementary to the obtuse angle 12d.

The loops 30b and 30d extend along another phantom line 13 intersecting the lateral sections 24 and 26. There is an acute angle 13a and an obtuse angle 13b between the phantom line 13 and the lateral section 24. The acute angle 13a is supplementary to the obtuse angle 13b. There is an acute angle 13c and an obtuse angle 13d between the phantom line 13 and the lateral section 26. The acute angle 13c is supplementary to the obtuse angle 13d.

The phantom lines 12 and 13 intersect each other. An area defined by the arched sections 31 of the loops 30a, 30b, 30c and 30d is located in an area defined by the apexes 35 of the loops 30a, 30b, 30c and 30d.

The lateral sections 24 and 26 are separated from each other by a distance 29. The distance 29 varies as the lateral sections 24 and 26 are pivoted relative to the barrel 40. The pivots 23 and 27 are located closer to each other as the distance 29 is reduced.

Referring to FIG. 4, the barrel 40 includes multiple panels 41 pivotally connected to one another so that the barrel 40 is collapsible. A bottom plate 42 is connected to or extends from a lower edge of the first panel 41. A handle 43 is pivotally connected to the first pane 41, above the bottom plate 42. Two cutouts 44 are made in the second panel 41 located next to the first panel 41. Another bottom plate 42 is connected to or extends from a lower edge of the third panel 41 located opposite to the first panel 41. Two cutouts 44 are made in the fourth panel 41 located opposite to the second panel 41. Two lugs 45 are connected to or formed on the fourth panel 41. Each of the cutouts 44 is located in the vicinity of a corresponding one of the lugs 45. At least one of the panels 41 includes an opening 46.

As mentioned above, the barrel 40 is collapsible. That is, the barrel 40 is switchable between an extended position shown in FIG. 4 and a collapsed position shown in FIGS. 5 and 6

A gas stove 50 is located in the barrel 40 in the extended position. The supporting unit 10 is supported on the barrel 40, above the gas stove 50. Each of the lateral sections 24 and 26 includes a portion inserted in one of the cutouts 44 made in the second panel 41 and another portion inserted in one of the cutouts 44 made in the fourth panel 41. Thus, the loops 30a, 30b, 30c and 30d are located at four corners of barrel 40 so that the supporting unit 10 extends above the gas stove 50. The pivots 23 and 27 are inserted in the lugs 45, respectively. Thus, the supporting unit 10 is allowed to pivot relative to the barrel 40. The bottom plates 42 increases the area of the bottom of the barrel 40 to allow the barrel 40 to stand firmly on a floor for example. The handle 43 facilitates handling of the barbecue grill, which consists of the barrel 40, the gas stove 50 and the supporting unit 10.

In use, a cooking utensil such as a pan, a pot and a grid is supported on the loops 30a, 30b, 30c and 30d supported on the frame 20 supported on the barrel 40. Air is admitted into the barrel 40 via the opening 46 to facilitate combustion of gas from the stove 50 located in the barrel 40.

Referring to FIGS. 5 and 6, the supporting unit 10 and the gas stove 50 are moved from the barrel 40 before the barrel 40 is moved to the collapsed position. The panels 41 are stacked when the barrel 40 is in the collapsed position.

To detach the supporting unit 10 from the barrel 40, the lateral sections 24 and 26 are pressed toward each other to disengage the pivots 23 and 27 from the lugs 45. The supporting unit 10 is flipped before the lateral sections 24 and 26 are pressed toward each other again to allow the pivots 23 and 27 to be aligned with the lugs 45. The lateral sections 24 and 26 are released to insert the pivots 23 in the lugs 45 again. Then, the frame 20 is located against the fourth panel 41 so that the loops 30a, 30b, 30c and 30d extend from the fourth panel 41. Thus, the entire barbecue grill occupies a minimum volume.

The present invention has been described via illustration of the preferred embodiment. Those skilled in the art can derive variations from the preferred embodiment without departing from the scope of the present invention. Therefore, the preferred embodiment shall not limit the scope of the present invention defined in the claims.

1. A barbecue grill comprising:
a barrel comprising:
panels pivotally connected to one another so that the barrel is switchable between an extended position and a collapsed position; and
two lugs formed on one of the panels; and
a supporting unit comprising:
a frame comprising two lateral sections extending parallel to each other and two pivots extending from the lateral sections, respectively, wherein the pivots are inserted in the lugs when the lateral sections are released, wherein the pivots are disengaged from the lugs when the lateral sections are moved relative to each other; and
loops located on and connected to the lateral sections.

2. The barbecue grill according to claim 1, wherein the loops are evenly located on the frame.

3. The barbecue grill according to claim 1, wherein each of the loops comprises a horizontal section connected to one of the lateral sections.

4. The barbecue grill according to claim 3, wherein each of the loops comprises a vertical section extending from the horizontal section, wherein the horizontal sections of the loops are located in the vertical sections of the loops.

5. The barbecue grill according to claim 4, wherein each of the loops comprises a slant section extending from the vertical section, above the horizontal section.

6. The barbecue grill according to claim 5, wherein each of the loops comprises an arched section extending between the slant section and the horizontal section, wherein the arched sections of the loops are located in the vertical sections of the loops.

7. The barbecue grill according to claim 1, wherein the frame comprises an intermediate section extending between the lateral sections.

8. The barbecue grill according to claim 3, wherein the frame comprises a reinforcing bar connected to the lateral sections, parallel to the intermediate section.

9. The barbecue grill according to claim 7, wherein the pivots extend parallel to the intermediate section.

10. The barbecue grill according to claim 1, wherein the pivots extend away from each other.

11. The barbecue grill according to claim 9, wherein the pivots are disengaged from the lugs when the lateral sections are pressed toward each other.
